(19) United States
(12) Patent Application Publication
(10) Pub. No.: US 2026/0292821 A1
(43) Pub. Date: Sep. 24, 2026

(54) PDCCH SKIPPING HANDING AFTER NACK TRANSMISSION

(71) Applicant: Nokia Technologies Oy, Espoo (FI)

(72) Inventors: Karri Markus RANTA-AHO, Espoo (FI); Chunli WU, Beijing (CN); Jorma Johannes KAIKKONEN, Oulu (FI)

(21) Appl. No.: 19/473,679

(22) PCT Filed: Apr. 18, 2023
(86) PCT No.: PCT/CN2023/089077

§ 371 Date: Oct. 8, 2025

(51) Int. Cl. H04W 72/1273; H04W 76/28

(52) U.S. Cl. CPC H04W 72/1273; H04W 76/28

(57) ABSTRACT

Example embodiments of the present disclosure relate to a terminal device, a network device, methods, apparatuses and a computer readable storage medium for a solution for PDCCH skipping handing after a NACK transmission in a multi-cell operation. In some embodiments, a terminal device may receive a DCI indicating to skip PDCCH monitoring for a duration on a scheduling cell that schedules a PDSCH transmission on a scheduled cell. If a NACK for the PDSCH transmission on the scheduled cell has been transmitted, the terminal device may further resume the PDCCH monitoring or terminate a PDCCH skipping on at least one serving cell, where the at least one serving cell comprises the scheduling cell that schedules the PDSCH transmission. As such, a communication between the terminal device and the network device may be maintained at least on the scheduling cell and a power consumption may be reduced as well.

### FIELD

Example embodiments of the present disclosure generally relate to the field of telecommunication and in particular, to a terminal device, a network device, methods, apparatuses and a computer readable storage medium for physical downlink control channel (PDCCH) skipping handing after a negative acknowledgement (NACK) transmission in a multi-cell operation.

### BACKGROUND

A PDCCH skipping functionality has been introduced in the third generation mobile communications (3GPP) Release 17 (Rel-17), where a terminal device, such as user equipment (UE), can skip PDCCH monitoring based on downlink control information (DCI) on Type 3 common search space for monitoring PDCCH (type-3 CSS) and UE-specific search space for monitoring PDCCH (USS) for the duration. However, in case the UE is configured with multiple serving cells, how to perform the PDCCH skipping should be further studied.

### SUMMARY

In general, example embodiments of the present disclosure provide a solution for PDCCH skipping handing after a NACK transmission in a multi-cell operation.

In a first aspect, there is provided a terminal device. The terminal device comprises at least one processor and at least one memory storing instructions that, when executed by the at least one processor, cause the terminal device at least to: receive, from a network device, downlink control information (DCI) indicating to skip physical downlink control channel (PDCCH) monitoring for a duration on a scheduling cell that schedules a physical downlink shared channel (PDSCH) transmission on a scheduled cell; and based on a determination that a negative acknowledgement (NACK) for the PDSCH transmission on the scheduled cell has been transmitted, resume the PDCCH monitoring or terminate a PDCCH skipping on at least one serving cell, wherein the at least one serving cell comprises the scheduling cell that schedules the PDSCH transmission.

In a second aspect, there is provided a network device. The network device comprises at least one processor and at least one memory storing instructions that, when executed by the at least one processor, cause the network device at least to: transmit, to a terminal device, downlink control information (DCI) indicating to skip physical downlink control channel (PDCCH) monitoring for a duration on a scheduling cell that schedules a physical downlink shared channel (PDSCH) transmission on a scheduled cell; and based on a determination that a negative acknowledgement (NACK) for the PDSCH transmission on the scheduled cell has been received, determine at least one serving cell on which the PDCCH monitoring is resumed or a PDCCH skipping is terminated by the terminal device, wherein the at least one serving cell comprises the scheduling cell that schedules the PDSCH transmission.

In a third aspect, there is provided a method performed by a terminal device. The method comprises: receiving, at a terminal device from a network device, downlink control information (DCI) indicating to skip physical downlink control channel (PDCCH) monitoring for a duration on a scheduling cell that schedules a physical downlink shared channel (PDSCH) transmission on a scheduled cell; and based on a determination that a negative acknowledgement (NACK) for the PDSCH transmission on the scheduled cell has been transmitted, resuming the PDCCH monitoring or terminating a PDCCH skipping on at least one serving cell, wherein the at least one serving cell comprises the scheduling cell that schedules the PDSCH transmission.

In a fourth aspect, there is provided a method performed by a network device. The method comprises: transmitting, at a network device to a terminal device, downlink control information (DCI) indicating to skip physical downlink control channel (PDCCH) monitoring for a duration on a scheduling cell that schedules a physical downlink shared channel (PDSCH) transmission on a scheduled cell; and based on a determination that a negative acknowledgement (NACK) for the PDSCH transmission on the scheduled cell has been received, determining at least one serving cell on which the PDCCH monitoring is resumed or a PDCCH skipping is terminated by the terminal device, wherein the at least one serving cell comprises the scheduling cell that schedules the PDSCH transmission.

In a fifth aspect, there is provided an apparatus. The apparatus comprises: means for receiving, at a terminal device from a network device, downlink control information (DCI) indicating to skip physical downlink control channel (PDCCH) monitoring for a duration on a scheduling cell that schedules a physical downlink shared channel (PDSCH) transmission on a scheduled cell; and means for based on a determination that a negative acknowledgement (NACK) for the PDSCH transmission on the scheduled cell has been transmitted, resuming the PDCCH monitoring or terminating a PDCCH skipping on at least one serving cell, wherein the at least one serving cell comprises the scheduling cell that schedules the PDSCH transmission.

In a sixth aspect, there is provided an apparatus. The apparatus comprises: means for transmitting, at a network device to a terminal device, downlink control information (DCI) indicating to skip physical downlink control channel (PDCCH) monitoring for a duration on a scheduling cell that schedules a physical downlink shared channel (PDSCH) transmission on a scheduled cell; and means for based on a determination that a negative acknowledgement (NACK) for the PDSCH transmission on the scheduled cell has been received, determining at least one serving cell on which the PDCCH monitoring is resumed or a PDCCH skipping is terminated by the terminal device, wherein the at least one serving cell comprises the scheduling cell that schedules the PDSCH transmission.

In a seventh aspect, there is provided a terminal device. The terminal device comprises: receiving circuitry configured to receive, from a network device, downlink control information (DCI) indicating to skip physical downlink control channel (PDCCH) monitoring for a duration on a scheduling cell that schedules a physical downlink shared channel (PDSCH) transmission on a scheduled cell; and performing circuitry configured to based on a determination that a negative acknowledgement (NACK) for the PDSCH transmission on the scheduled cell has been transmitted, resume the PDCCH monitoring or terminate a PDCCH skipping on at least one serving cell, wherein the at least one serving cell comprises the scheduling cell that schedules the PDSCH transmission.

In an eighth aspect, there is provided a network device. The network device comprises: transmitting circuitry configured to transmit, to a terminal device, downlink control information (DCI) indicating to skip physical downlink control channel (PDCCH) monitoring for a duration on a scheduling cell that schedules a physical downlink shared channel (PDSCH) transmission on a scheduled cell; and determining circuitry configured to based on a determination that a negative acknowledgement (NACK) for the PDSCH transmission on the scheduled cell has been received, determine at least one serving cell on which the PDCCH monitoring is resumed or a PDCCH skipping is terminated by the terminal device, wherein the at least one serving cell comprises the scheduling cell that schedules the PDSCH transmission.

In a ninth aspect, there is provided a non-transitory computer readable medium comprising program instructions for causing an apparatus to perform at least the method in the third or fourth aspect.

In a tenth aspect, there is provided a computer program comprising instructions, which, when executed by an apparatus, cause the apparatus at least to perform the method in the third or fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example of a network environment in which some example embodiments of the present disclosure may be implemented;

FIG. 2A illustrates a schematic diagram of carrier aggregation with self-scheduling in which some example embodiments of the present disclosure may be implemented;

FIG. 2B illustrates a schematic diagram of carrier aggregation with cross-carrier scheduling in which some example embodiments of the present disclosure may be implemented;

FIG. 2C illustrates a schematic diagram of a grouping of cells to DRX groups in which some example embodiments of the present disclosure may be implemented;

FIG. 3 illustrates an example of a process flow in accordance with some example embodiments of the present disclosure;

FIG. 4 illustrates a flowchart of a method implemented at a terminal device in accordance with some example embodiments of the present disclosure;

FIG. 5 illustrates a flowchart of a method implemented at a network device in accordance with some example embodiments of the present disclosure;

FIG. 6 illustrates a simplified block diagram of a device that is suitable for implementing some example embodiments of the present disclosure; and

FIG. 7 illustrates a block diagram of an example of a computer readable medium in accordance with some example embodiments of the present disclosure.

Throughout the drawings, the same or similar reference numerals represent the same or similar elements.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), New Radio (NR), Wideband Code Division Multiple Access (WCDMA), High-Speed Packet Access (HSPA), Narrow Band Internet of Things (NB-IoT) and so on. Furthermore, the communications in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a new radio (NR) NB (also referred to as a gNB), a Remote Radio Unit (RRU), a radio header (RH), a remote radio head (RRH), an integrated access and backhaul (IAB) node, a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a machine type communication (MTC) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As mentioned above, a terminal device, such as a UE, can skip PDCCH monitoring based on downlink control information (DCI) on Type 3 common search space for monitoring PDCCH (type-3 CSS) and UE-specific search space for monitoring PDCCH (USS) for the duration determined by the skipping indication, e.g., in a 2-bit indication field, each indication is associated with a radio resource control (RRC) configured duration. The PDCCH skipping behavior described in TS38.213 is cell specific, e.g., applied on an active downlink (DL) bandwidth part (BWP).

Since new radio (NR) UE may be configured with multiple serving cells (they may include both DL and UL, or only DL), i.e., carrier aggregation. For each serving cell, it could be configured its PUCCH is on PCell/SpCell, or on PUCCH SCell if PUCCH SCell is configured.

It is beneficial to terminate PDCCH skipping (or equivalently resume PDCCH monitoring) when a NACK is sent in UL. By introducing this functionality, the network can configure longer skipping durations without negatively affecting the DL traffic KPIs enabling better power saving in the UE (due to longer skipping durations). However, in case multiple serving cells are configured, how to implement the functionality needs to be further studied considering UE power saving, but also maintain and enabling network scheduling flexibility.

Example embodiments of the present disclosure provide a solution for PDCCH skipping handing after a NACK transmission in a multi-cell operation. In some embodiments, a terminal device may receive a DCI indicating to skip PDCCH monitoring for a duration on a scheduling cell that schedules a PDSCH transmission on a scheduled cell. If a NACK for the PDSCH transmission on the scheduled cell has been transmitted (by the terminal device), the terminal device may further resume the PDCCH monitoring or terminate a PDCCH skipping on at least one serving cell, where the at least one serving cell comprises the scheduling cell that schedules the PDSCH transmission. As such, a communication between the terminal device and the network device may be maintained at least on the scheduling cell and the power consumption may be reduced as well. Principles and some example embodiments of the present disclosure will be described in detail below with reference to the accompanying drawings.

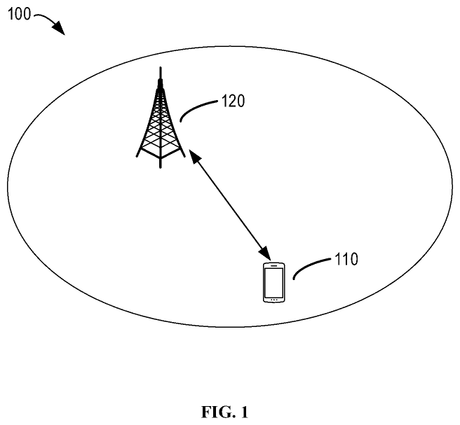

FIG. 1 illustrates an example of a network environment 100 in which some example embodiments of the present disclosure may be implemented. The environment 100, which may be a part of a communication network, comprises a terminal device 110 and a network device 120. The network environment 100 may also be called as a network system, a communication environment, a communication network, a communication system, or the like, the present disclosure does not limit this aspect.

The environment 100 may comprise any suitable number of devices and cells. In the environment 100, the network device 120 can provide services to the terminal device 110, and the network device 120 and the terminal device 110 may communicate data and control information with each other. In some embodiments, the network device 120 and the terminal device 110 may communicate with direct links/channels.

In the system 100, a link from the network device 120 to the terminal device 110 is referred to as a downlink (DL), while a link from the terminal device 110 to the network device 120 is referred to as an uplink (UL). In downlink, the network device 120 is a transmitting (TX) device (or a transmitter) and the terminal device 110 is a receiving (RX) device (or a receiver). In uplink, the terminal device 110 is a transmitting TX device (or a transmitter) and the network device 120 is a RX device (or a receiver). It is to be understood that the network device 120 may provide one or more serving cells. In some embodiments, the network device 120 can provide multiple cells.

Communications in the network environment 100 may be implemented according to any proper communication protocol(s), comprising, but not limited to, cellular communication protocols of the first generation (1G), the second generation (2G), the third generation (3G), the fourth generation (4G), the fifth generation (1G) and the sixth generation (6G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the numbers of devices (i.e., the terminal device 110 and the network device 120) and their connection relationships and types shown in FIG. 1 are only for the purpose of illustration without suggesting any limitation. For example, the environment 100 may include any suitable numbers of devices adapted for implementing embodiments of the present disclosure. For example, while FIG. 1 depicts the terminal device 110 as a mobile phone; the terminal device 110 may be any type of user equipment.

In some example embodiments, the network device 120 may provide multiple serving cells for the terminal device 110. For example, there may be a primary cell (PCell) and a secondary cell (SCell). It is to be understood there may be more cells, such as a SpCell, etc., and the present disclosure does not limit this aspect.

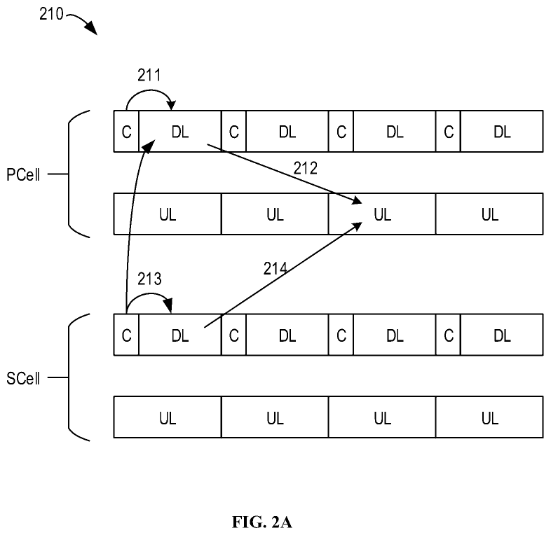

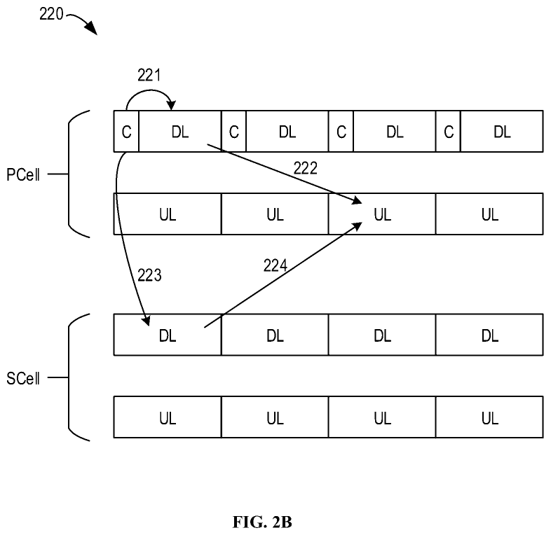

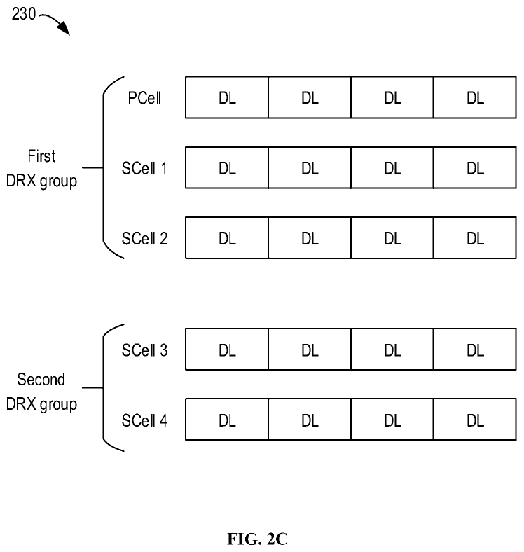

FIG. 2A illustrates a schematic diagram 210 of carrier aggregation (CA) with self-scheduling in which some example embodiments of the present disclosure may be implemented. The schematic diagram 210 illustrates a basic carrier aggregation setup where each cell schedules itself. As shown in FIG. 2A, there are PCell and SCell in multi-cell deployment, each cell does self-scheduling.

As shown at 211, the PCell DCI on PDCCH (C) is detected on a PDCCH monitoring occasion of a search space on the PCell, the DCI schedules a PCell PDSCH. The PDSCH can be in the same slot as where the PDCCH carrying the DCI was detected, or it can be in a later slot.

As shown at 212, the hybrid automatic repeat request-ackowledgement (HARQ-ACK) feedback (ACK or NACK) of the PCell PDSCH is mapped to the PCell uplink.

As shown at 213, the SCell DCI on PDCCH (C) is detected on a PDCCH monitoring occasion of a search space on the SCell, the DCI schedules a SCell PDSCH. The PDSCH can be in the same slot as where the PDCCH carrying the DCI was detected, or it can be in a later slot

As shown at 214, the HARQ-ACK feedback (ACK or NACK) of the SCell PDSCH is mapped to the PCell uplink.

Each of the PCell and the SCell does self-scheduling that the NACK corresponds to a different cell than the skipping indication (included in a DCI). For example, the Scell DCI may indicate skipping and schedule PDSCH, while PCell only schedules PDSCH (without skipping). The HARQ feedback is carried by (joint) PUCCH. Then the NACK could correspond to PDSCH carried in the PCell, but skipping cancellation would be applied in Scell.

FIG. 2B illustrates a schematic diagram 220 of carrier aggregation with cross-carrier scheduling in which some example embodiments of the present disclosure may be implemented. As shown in FIG. 2B, there are PCell and SCell in multi-cell deployment. The schematic diagram 220 illustrates a cross-carrier scheduling carrier aggregation setup where the SCell is scheduled by the PCell.

As shown at 221, the PCell DCI on PDCCH (C) is detected on a PDCCH monitoring occasion of a search space on the PCell, the DCI schedules a PCell PDSCH. The PDSCH can be in the same slot as where the PDCCH carrying the DCI was detected, or it can be in a later slot

As shown at 222, the HARQ-ACK feedback (ACK or NACK) of the PCell PDSCH is mapped to the PCell uplink.

As shown at 223, the PCell DCI on PDCCH (C) is detected on a PDCCH monitoring occasion of a search space on the PCell, the DCI scheduling a SCell PDSCH.

As shown at 224, the HARQ-ACK feedback (ACK or NACK) of the SCell PDSCH is mapped to the PCell uplink.

The rules for mapping the HARQ-ACK feedback of a PDSCH in carrier aggregation setup are shown in Table 1 below. If a PUCCH SCell is configured, then for the cells in the same group with the PUCCH SCell the PUCCH SCell behaves as the PCell in the Table 1 below.

TABLE 1

| PUSCH on | PUSCH on | HARQ-ACK |
|---|---|---|
| PCell Uplink | SCell Uplink | mapped on |
| Not present | Not present | PUCCH on PCell |
| Present | Not present | PUSCH on PCell |
| Present | Present | PUSCH on PCell |
| Not present | Present | PUSCH on SCell |

It is noted that the CA configuration can be for DL only, in which case only the PCell has any uplink and the HARQ-ACK feedback is always on the PCell uplink. The guiding principle is that acknowledgement of all the downlinks are mapped to one uplink.

FIG. 2C illustrates a schematic diagram 230 of a grouping of cells to DRX groups in which some example embodiments of the present disclosure may be implemented. As shown in FIG. 2C, there are a first DRX group and a second DRX group. The first DRX group includes PCell, SCell 1, and SCell 2, while the second DRX group includes SCell 3 and SCell 4.

It is to be understood that although a total number if cells in 5 in FIG. 2C, it is only for the purpose of illustration without suggesting any limitation, for example, there may be more cells or less cells. Although each DRX group includes two or more cells, in some other cases, there may be only one cell in a DRX group. In some examples, in a carrier aggregation configuration, cells can be grouped into DRX groups. All the cells in the CA configuration could map to the same DRX group, or each DRX group can consist of just one cell, or anything in between.

It is to be understood that although only DL is shown for each cell shown in FIG. 2C, it is only for the purpose of illustration without suggesting any limitation. For example, the PCell has both UL and DL. For example, one of the SCells 1-4 may have both UL and DL too.

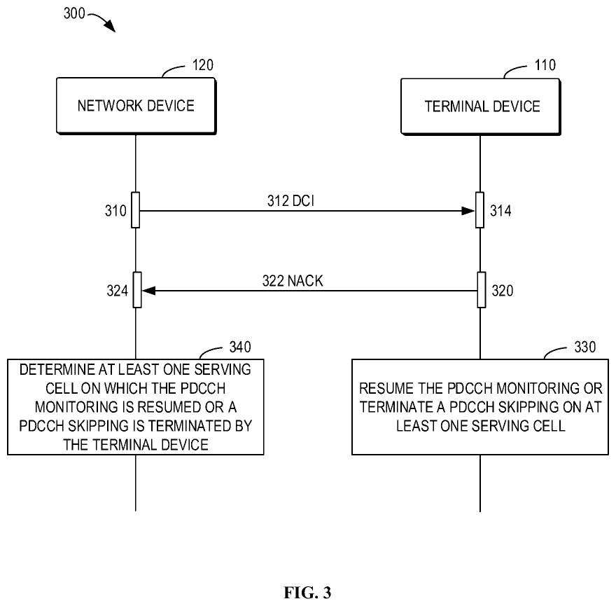

FIG. 3 illustrates an example of a process flow 300 in accordance with some example embodiments of the present disclosure. For the purpose of discussion, the process flow 300 will be described with reference to FIG. 1. The process flow 300 involves the terminal device 110 and the network device 120. It would be appreciated that although the process flow 300 has been described in the network environment 100 of FIG. 1, this process flow may be likewise applied to other communication scenarios.

The network device 120 transmits 310 a DCI 312 to the terminal device 110, where the DCI 312 may indicate to skip PDCCH monitoring for a duration on a scheduling cell that schedules a PDSCH transmission on a scheduled cell. On the other side of communication, the terminal device 110 receives 314 the DCI 312. The duration may be configured in the DCI or have been preconfigured via RRC signaling, for example.

The terminal device 110 transmits 320 a NACK 322 to the network device 120, where the NACK may be associated with the PDSCH transmission on the scheduled cell. On the other side of communication, the network device 120 receives 324 the NACK 322.

In addition, the terminal device 110 resumes the PDCCH monitoring or terminates a PDCCH skipping on at least one serving cell at 330, e.g. on at least the scheduling cell. Similarly, the network device 120 determines 340 the at least one serving cell on which the PDCCH monitoring is resumed or a PDCCH skipping is terminated by the terminal device 110.

In some example embodiments, the NACK may be transmitted on a physical uplink control channel (PUCCH) or a physical uplink shared channel (PUSCH) of a feedback cell. For example, the feedback cell may be a special cell or a PUCCH secondary cell (SCell).

In some example embodiments, the scheduling cell and the scheduled cell are a same serving cell. In some examples, in case a self-scheduling is used, the scheduling cell and the scheduled cell may be the same.

In some other example embodiments, the scheduling cell and the scheduled cell may be different, e.g., in case a cross-carrier scheduling is used.

In some example embodiments, the terminal device 110 may resume the PDCCH monitoring or terminate a PDCCH skipping on at least one serving cell after the transmission of the NACK, e.g., after a last time unit (such as last symbol) of the PUCCH or the PUSCH providing the NACK, or a known time duration after that last time unit. For example, the terminal device 110 may resume the PDCCH monitoring or terminate a PDCCH skipping on at least one serving cell at the beginning of the first slot after the last symbol of the PUCCH or the PUSCH providing the NACK.

In some example embodiments, the at least one serving cell includes the scheduling cell that schedules the PDSCH transmission. As such, it is proposed a termination of the PDCCH skipping at least for the scheduling serving cell of the PDSCH transmission after NACK is sent for the PDSCH transmission. As a consequence, the terminal device is capable of detecting the PDSCH resources for the retransmission following the NACK.

In some examples, the at least one serving cell may only include the scheduling cell, i.e., the scheduling serving cell. For example, if the terminal device 120 transmits PUCCH or PUSCH providing a NACK for a PDSCH transmission of a scheduled cell, after the terminal device 120 detects a DCI format providing the PDCCH monitoring adaptation field indicating to skip PDCCH monitoring for the duration on the scheduling cell that scheduled the PDSCH to which the NACK is sent, terminal device 120 shall resume PDCCH monitoring (or terminate PDCCH skipping) only on the scheduling cell that scheduled the PDSCH to which the NACK is sent.

Accordingly, from UE power consumption point of view, as the terminal device 120 only needs to wake up for the scheduling cell which might schedule retransmission of the NACKed PDSCH.

In some other example embodiments, the at least one serving cell may include multiple cells in a discontinuous reception (DRX) group which the scheduling cell belongs to.

In some examples, if the terminal device 120 transmits PUCCH or PUSCH providing a NACK for a PDSCH transmission of a scheduled cell, after the terminal device 120 detects a DCI format providing the PDCCH monitoring adaptation field indicating to skip PDCCH monitoring for the duration on the scheduling cell that scheduled the PDSCH to which the NACK is sent, terminal device 120 shall resume PDCCH monitoring (or terminate PDCCH skipping) on the cells of the DRX group in which the scheduling cell that scheduled the PDSCH corresponding to the transmitted NACK.

For example, while with reference to FIG. 2C, if the scheduling cell is PCell in the first DRX group, then the at least one serving cell includes PCell, SCell 1, and SCell 2. In other words, the terminal device 110 may resume PDCCH monitoring (or terminate PDCCH skipping) on PCell, SCell 1, and SCell 2.

As such, it enables a network implementation possibility to choose to re-send the PDSCH from another cell as new transmission.

In some other example embodiments, the at least one serving cell may include all serving cells of a media access control (MAC) entity which the scheduling cell belongs to.

In some examples, if the terminal device 120 transmits PUCCH or PUSCH providing a NACK for a PDSCH transmission of a scheduled cell, after the terminal device 120 detects a DCI format providing the PDCCH monitoring adaptation field indicating to skip PDCCH monitoring for the duration on the scheduling cell that scheduled the PDSCH to which the NACK is sent, terminal device 120 shall resume PDCCH monitoring (or terminate PDCCH skipping) on all the serving cells of the MAC entity. As such, it enables a network NW implementation possibility to choose to re-send the PDSCH from another cell as new transmission.

In some other example embodiments, the at least one serving cell may include multiple cells each of which is able to act as the scheduling cell.

In some examples, if the terminal device 120 transmits PUCCH or PUSCH providing a NACK for a PDSCH transmission of a scheduled cell, after the terminal device 120 detects a DCI format providing the PDCCH monitoring adaptation field indicating to skip PDCCH monitoring for the duration on the scheduling cell that scheduled the PDSCH to which the NACK is sent, terminal device 120 shall resume PDCCH monitoring (or terminate PDCCH skipping) on all cells that can act as scheduling cells to the cell where the PDSCH was scheduled on.

For example, while with reference to FIG. 2A, if the PDSCH transmission is on PCell, i.e., the scheduled cell, the scheduling cell may be PCell or SCell, then the at least one serving cell includes PCell and SCell. In other words, the terminal device 110 may resume PDCCH monitoring (or terminate PDCCH skipping) on PCell and SCell.

For example, in one carrier aggregation (CA) configuration, a serving cell PDSCH can be self-scheduled or cross-carrier scheduled. For example, in one carrier aggregation (CA) configuration, one DCI can schedule PDSCHs in multiple cells, while each cell is also monitoring a self-scheduling DCI.

With reference to FIG. 3, since the NACK is transmitted and the PDCCH monitoring is resumed or a PDCCH skipping is terminated by the terminal device 110 on the at least one serving cell, the network device 120 may further retransmit the PDSCH. Accordingly, a transmission latency may be reduced and the transmission efficiency may be improved.

According to the embodiments with reference to FIG. 3, a solution for PDCCH skipping handing after a NACK transmission in a multi-cell operation. In some embodiments, a terminal device may receive a DCI indicating to skip PDCCH monitoring for a duration on a scheduling cell that schedules a PDSCH transmission on a scheduled cell. If a NACK for the PDSCH transmission on the scheduled cell has been transmitted, the terminal device may further resume the PDCCH monitoring or terminate a PDCCH skipping on at least one serving cell, where the at least one serving cell comprises the scheduling cell that schedules the PDSCH transmission. As such, a retransmission may be continued performing on the at least one serving cell. Therefore, the transmission efficiency may be guaranteed.

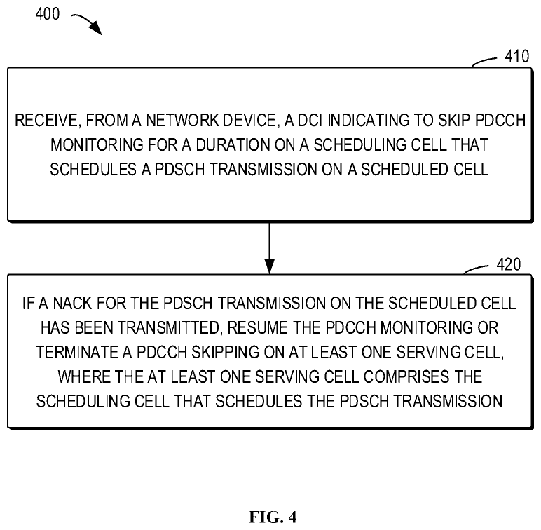

FIG. 4 illustrates a flowchart of a method 400 implemented at a terminal device in accordance with some example embodiments of the present disclosure. For the purpose of discussion, the method 400 will be described from the perspective of the terminal device 110 with reference to FIG. 1.

At block 410, the terminal device 110 receives, from a network device, a DCI indicating to skip PDCCH monitoring for a duration on a scheduling cell that schedules a PDSCH transmission on a scheduled cell. At block 420, if a NACK for the PDSCH transmission on the scheduled cell has been transmitted, the terminal device 110 resumes the PDCCH monitoring or terminates a PDCCH skipping on at least one serving cell, where the at least one serving cell comprises the scheduling cell that schedules the PDSCH transmission.

In some example embodiments, the at least one serving cell comprises multiple cells in a DRX group (such as all cells in the DRX group) which the scheduling cell belongs to.

In some example embodiments, the at least one serving cell comprises all serving cells of the MAC entity which the scheduling cell belongs to.

In some example embodiments, the at least one serving cell comprises multiple cells each of which is able to act as the scheduling cell.

In some example embodiments, the NACK is transmitted on a PUCCH or a PUSCH of a feedback cell. In some example embodiments, the feedback cell is a special cell or a PUCCH SCell.

In some example embodiments, the scheduling cell and the scheduled cell are a same serving cell. In some example embodiments, the scheduling cell and the scheduled cell are different.

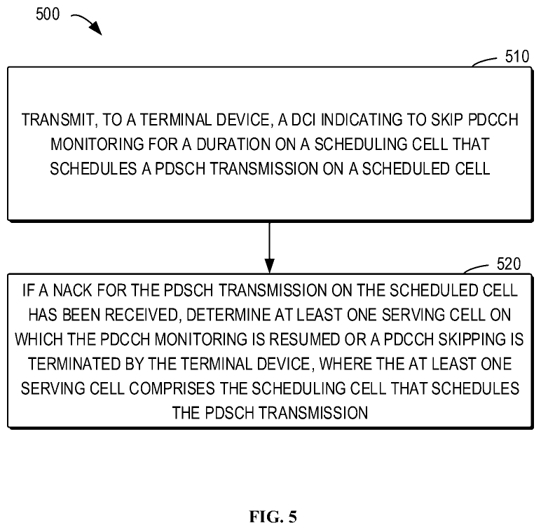

FIG. 5 illustrates a flowchart of a method 500 implemented at a network device in accordance with some example embodiments of the present disclosure. For the purpose of discussion, the method 500 will be described from the perspective of the network device 120 with reference to FIG. 1.

At block 510, the network device 120 transmits, to a terminal device, a DCI indicating to skip PDCCH monitoring for a duration on a scheduling cell that schedules a PDSCH transmission on a scheduled cell. At block 520, if a NACK for the PDSCH transmission on the scheduled cell has been received, the network device 120 determines at least one serving cell on which the PDCCH monitoring is resumed or a PDCCH skipping is terminated by the terminal device, where the at least one serving cell comprises the scheduling cell that schedules the PDSCH transmission.

In some example embodiments, the at least one serving cell comprises multiple cells in a DRX group (such as all cells in the DRX group) which the scheduling cell belongs to.

In some example embodiments, the at least one serving cell comprises all serving cells of the MAC entity which the scheduling cell belongs to.

In some example embodiments, the at least one serving cell comprises multiple cells each of which is able to act as the scheduling cell.

In some example embodiments, the NACK is transmitted on a PUCCH or a PUSCH of a feedback cell. In some example embodiments, the feedback cell is a special cell or a PUCCH SCell.

In some example embodiments, the scheduling cell and the scheduled cell are a same serving cell. In some example embodiments, the scheduling cell and the scheduled cell are different.

In some example embodiments, an apparatus capable of performing the method 400 (for example, the terminal device 110) may comprise means for performing the respective steps of the method 400. The means may be implemented in any suitable form. For example, the means may be implemented in a circuitry or software module.

In some example embodiments, the apparatus comprises: means for receiving, from a network device, a DCI indicating to skip PDCCH monitoring for a duration on a scheduling cell that schedules a PDSCH transmission on a scheduled cell; and means for based on a determination that a negative acknowledgement (NACK) for the PDSCH transmission on the scheduled cell has been transmitted, resume the PDCCH monitoring or terminate a PDCCH skipping on at least one serving cell, where the at least one serving cell comprises the scheduling cell that schedules the PDSCH transmission.

In some example embodiments, the at least one serving cell comprises multiple cells in a DRX group (such as all cells in the DRX group) which the scheduling cell belongs to.

In some example embodiments, the at least one serving cell comprises all serving cells of the MAC entity which the scheduling cell belongs to.

In some example embodiments, the at least one serving cell comprises multiple cells each of which is able to act as the scheduling cell.

In some example embodiments, the NACK is transmitted on a PUCCH or a PUSCH of a feedback cell. In some example embodiments, the feedback cell is a special cell or a PUCCH SCell.

In some example embodiments, the scheduling cell and the scheduled cell are a same serving cell. In some example embodiments, the scheduling cell and the scheduled cell are different.

In some example embodiments, an apparatus capable of performing the method 500 (for example, the network device 120 may comprise means for performing the respective steps of the method 500. The means may be implemented in any suitable form. For example, the means may be implemented in a circuitry or software module.

In some example embodiments, the apparatus comprises: means for transmitting, to a terminal device, a DCI indicating to skip PDCCH monitoring for a duration on a scheduling cell that schedules a PDSCH transmission on a scheduled cell; and means for based on a determination that a NACK for the PDSCH transmission on the scheduled cell has been received, determine at least one serving cell on which the PDCCH monitoring is resumed or a PDCCH skipping is terminated by the terminal device, where the at least one serving cell comprises the scheduling cell that schedules the PDSCH transmission.

In some example embodiments, the at least one serving cell comprises multiple cells in a DRX group (such as all cells in the DRX group) which the scheduling cell belongs to.

In some example embodiments, the at least one serving cell comprises all serving cells of the MAC entity which the scheduling cell belongs to.

In some example embodiments, the at least one serving cell comprises multiple cells each of which is able to act as the scheduling cell.

In some example embodiments, the NACK is transmitted on a PUCCH or a PUSCH of a feedback cell. In some example embodiments, the feedback cell is a special cell or a PUCCH SCell.

In some example embodiments, the scheduling cell and the scheduled cell are a same serving cell. In some example embodiments, the scheduling cell and the scheduled cell are different.

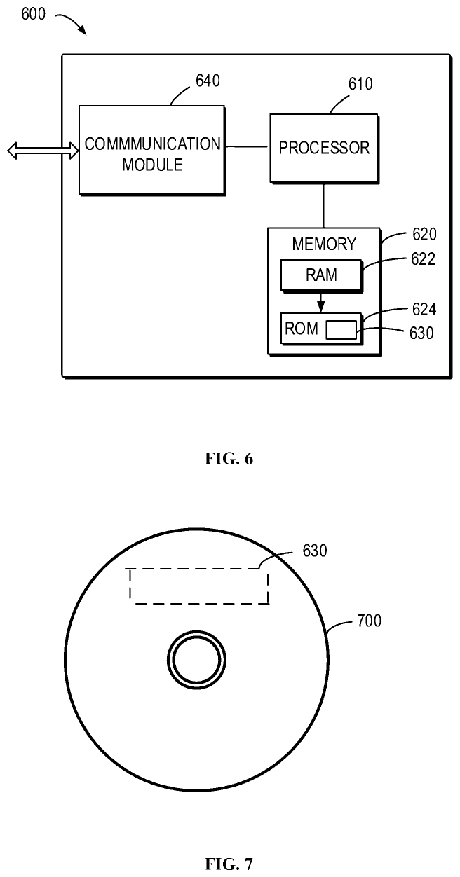

FIG. 6 illustrates a simplified block diagram of a device 600 that is suitable for implementing some example embodiments of the present disclosure. The device 600 may be provided to implement the communication device, for example the terminal device 110 or the network device 120 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has at least one antenna to facilitate communication. The communication interface may represent any interface that is necessary for communication with other network elements.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 624. The processor 610 may perform any suitable actions and processing by loading the program 630 into the RAM 622.

The embodiments of the present disclosure may be implemented by means of the program 630 so that the device 600 may perform any process of the disclosure as discussed with reference to FIGS. 3-5. The embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like.

FIG. 7 illustrates a block diagram of an example of a computer readable medium 700 in accordance with some example embodiments of the present disclosure. The computer readable medium 700 has the program 630 stored thereon. It is noted that although the computer readable medium 700 is depicted in form of CD or DVD in FIG. 7, the computer readable medium 700 may be in any other form suitable for carry or hold the program 630.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method as described above with reference to any of FIGS. 4-5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device comprising:
at least one processor; and
at least one memory storing instructions that, when executed by the at least one processor, cause the terminal device at least to:
receive, from a network device, downlink control information (DCI) indicating to skip physical downlink control channel (PDCCH) monitoring for a duration on a scheduling cell that schedules a physical downlink shared channel (PDSCH) transmission on a scheduled cell; and
based on a determination that a negative acknowledgement (NACK) for the PDSCH transmission on the scheduled cell has been transmitted, resume the PDCCH monitoring or terminate a PDCCH skipping on at least one serving cell, wherein the at least one serving cell comprises the scheduling cell that schedules the PDSCH transmission.

2. The terminal device of claim 1, wherein the at least one serving cell comprises a plurality of cells in a discontinuous reception (DRX) group which the scheduling cell belongs to.

3. The terminal device of claim 1, wherein the at least one serving cell comprises all serving cells of a media access control (MAC) entity which the scheduling cell belongs to.

4. The terminal device of claim 1, wherein the at least one serving cell comprises a plurality of cells each of which is able to act as the scheduling cell.

5. The terminal device of claim 1, wherein the NACK is transmitted on a physical uplink control channel (PUCCH) or a physical uplink shared channel (PUSCH) of a feedback cell.

6. The terminal device of claim 5, wherein the feedback cell is a special cell or a PUCCH secondary cell (SCell).

7. The terminal device of claim 1, wherein the scheduling cell and the scheduled cell are a same serving cell.

8. A network device comprising:
at least one processor; and
at least one memory storing instructions that, when executed by the at least one processor, cause the network device at least to:
transmit, to a terminal device, downlink control information (DCI) indicating to skip physical downlink control channel (PDCCH) monitoring for a duration on a scheduling cell that schedules a physical downlink shared channel (PDSCH) transmission on a scheduled cell; and
based on a determination that a negative acknowledgement (NACK) for the PDSCH transmission on the scheduled cell has been received, determine at least one serving cell on which the PDCCH monitoring is resumed or a PDCCH skipping is terminated by the terminal device, wherein the at least one serving cell comprises the scheduling cell that schedules the PDSCH transmission.

9. The network device of claim 8, wherein the at least one serving cell comprises a plurality of cells in a discontinuous reception (DRX) group which the scheduling cell belongs to.

10. The network device of claim 8, wherein the at least one serving cell comprises all serving cells of a media access control (MAC) entity which the scheduling cell belongs to.

11. The network device of claim 8, wherein the at least one serving cell comprises a plurality of cells each of which is able to act as the scheduling cell.

12. The network device of claim 8, wherein the NACK is transmitted on a physical uplink control channel (PUCCH) or a physical uplink shared channel (PUSCH) of a feedback cell.

13. The network device of claim 12, wherein the feedback cell is a special cell or a PUCCH secondary cell (SCell).

14. The network device of claim 8, wherein the scheduling cell and the scheduled cell are a same serving cell.

15. A method comprising:
receiving, at a terminal device from a network device, downlink control information (DCI) indicating to skip physical downlink control channel (PDCCH) monitoring for a duration on a scheduling cell that schedules a physical downlink shared channel (PDSCH) transmission on a scheduled cell; and
based on a determination that a negative acknowledgement (NACK) for the PDSCH transmission on the scheduled cell has been transmitted, resuming the PDCCH monitoring or terminating a PDCCH skipping on at least one serving cell, wherein the at least one serving cell comprises the scheduling cell that schedules the PDSCH transmission.

16-19. (canceled)
